(19) United States
(12) Patent Application Publication
(10) Pub. No.: US 2018/0341475 A1
(43) Pub. Date: Nov. 29, 2018

(54) Just In Time Deployment with Package Managers

(71) Applicant: Dell Products L.P., Round Rock, TX (US)

(72) Inventor: Luis E. Bocaletti, Chicago, IL (US)

(73) Assignee: Dell Products L.P., Round Rock, TX (US)

(21) Appl. No.: 15/603,689

(22) Filed: May 24, 2017

(51) Int. Cl. G06F 9/445; H04L 29/08

(52) U.S. Cl. CPC G06F 8/65; H04L 67/34

(57) ABSTRACT

A system, method, and computer-readable medium are disclosed for performing a deployment operation, comprising: receiving an application module command request; accessing a metadata repository for application modules to obtain metadata corresponding to the application module; determining whether an application module corresponding to the application module command request is loaded within an application based upon metadata corresponding to the application module; contacting a package manager to download an application module package if the application module is not loaded within the application or an update to the application module exists; loading the application module package; and, providing an invocation to an entry point of the application module.

### BACKGROUND OF THE INVENTION

### Field of the Invention

The present invention relates to information handling systems. More specifically, embodiments of the invention relate to deploying modules to an application.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to deploy applications from one information handling system to another information handling system. It is known to execute application functionality on one information handling system by accessing the application from another information handling system.

### SUMMARY OF THE INVENTION

A system, method, and computer-readable medium are disclosed for performing a deployment operation, comprising: receiving an application module command request; accessing a metadata repository for application modules to obtain metadata corresponding to the application module; determining whether an application module corresponding to the application module command request is loaded within an application based upon metadata corresponding to the application module; contacting a package manager to download an application module package if the application module is not loaded within the application or an update to the application module exists; loading the application module package; and, providing an invocation to an entry point of the application module.

In certain embodiments, the deployment operation transparently performs partial application deployments when new functionality and/or updates to an application become available. In certain embodiments, the deployment operation accesses a metadata repository for application modules. The metadata repository stores application module metadata. In certain embodiments, the application module metadata includes information about a package manager endpoint and packager for each application module. In certain embodiments, the application module metadata includes information about the entry point for each application module. When an application module is invoked by a client at run time, the application accesses the metadata for the application module which is stored within the metadata repository. If the module is not loaded at the client or an update exists, the application contacts a package manager to download an application module package. The application then loads the application module package in memory and provides the invocation to the entry point of the module.

Such a deployment operation advantageously uses package managers to distribute and deploy application functionality. Such a deployment operation provides a convenient way to deploy new functionality within an information technology environment. Such a deployment operation provides a way for an application to seamlessly update itself. Such a deployment operation can be used as a base for a mini Micro-Services Architecture. Such a deployment operation advantageously defers deployment of functionality and/or updates until the functionality and/or updates are actually needed.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the system and method of the present invention.

FIG. 2 is a simplified block diagram of a deployment environment.

FIG. 3 shows a block diagram of the operation of a deployment environment when a command is sent to a module that is not loaded on a client.

FIG. 4 shows a flow chart of a deployment operation when a command is sent to a module that is not loaded on a client.

FIG. 5 shows a block diagram of the operation of a deployment environment when a command is sent to a module that is current.

FIG. 6 shows a flow chart of a deployment operation when a command is sent to a module that is current.

FIG. 7 shows a block diagram of the operation of a deployment environment when a command is sent to a module that has a more recent version which is not loaded on a client.

FIG. 8 shows a flow chart of a deployment operation when a command is sent to a module that has a more recent version which is not loaded on a client.

### DETAILED DESCRIPTION

Aspects of the present disclosure include an appreciation that with many known systems for deploying applications even small changes in functionality of the application can require deployment of the entire application.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

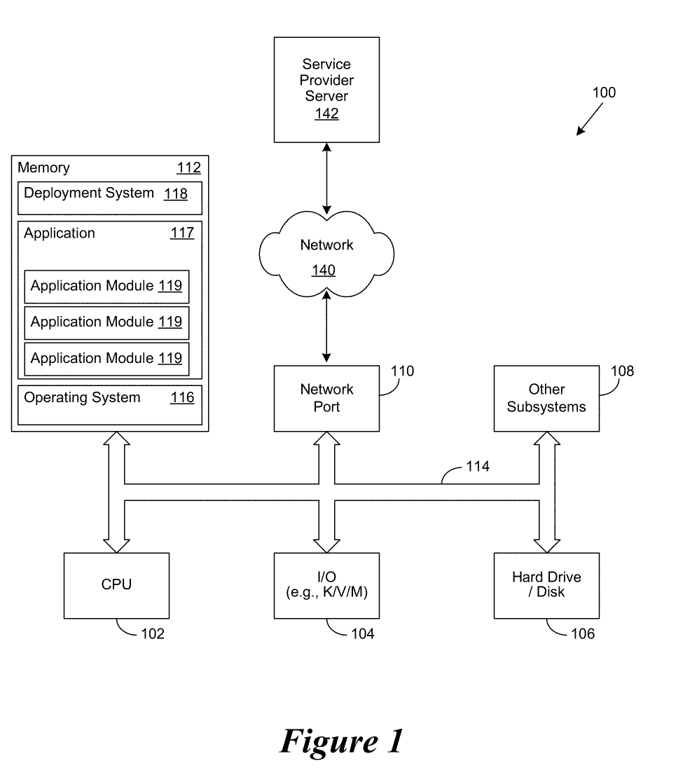

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise an application 117 and/or a deployment system 118. In various embodiments, the application 117 may further comprise one or more application modules 119. In one embodiment, the information handling system 100 is able to download the deployment system 118 from the service provider server 142. In another embodiment, the deployment system 118 is provided as a service from the service provider server 142.

The deployment system 118 performs a deployment operation. The deployment operation deploys an application from a host to a client. The deployment operation improves processor efficiency (and thus the efficiency of the information handling system 100) by deploying application modules on a just in time basis rather than needing an entire application to be deployed to update modules within the application. For the purposes of this disclosure an application module may be defined as a contained set of functionalities for an application.

As will be appreciated, once the information handling system 100 is configured to perform the deployment operation, the information handling system 100 becomes a specialized computing device specifically configured to perform the deployment operation and is not a general purpose computing device. Moreover, the implementation of the deployment operation on the information handling system 100 improves the functionality of the information handling system and provides a useful and concrete result of efficiently deploying application modules from a host to a client.

Such a deployment system effectively converts an application into a plugin system. New modules can be added, removed and updated without having to touch the main application or even having to stop it. Such a deployment system advantageously enables adding of functionality to an application simply by publishing a package and updating the metadata configuration. Such a deployment system advantageously enables updating functionality by publishing a new version of a package. The next invocation of the module automatically causes a just in time deployment of the updated functionality. Such a deployment system advantageously allows automatic removal of application functionality simply by removing metadata for a module. Such a deployment system advantageously enables deployment to be a feature of the application, rather than being a responsibility of the development team and the development personnel. Such a deployment system advantageously effectively isolates application modules within the system which then allows other team members to contribute additional plugins to the application without any contention. Providing the deployment system with the ability to deploy application without having to stop the system drastically reduces the downtime of the overall application. Because each module is self-contained, the deployment system may be used as a platform for micro-services. With the disclosed deployment system hosts can execute in clusters in such way that different modules can be loaded in different nodes. This allows a system which incorporates the disclosed deployment system to scale horizontally with minimum effort.

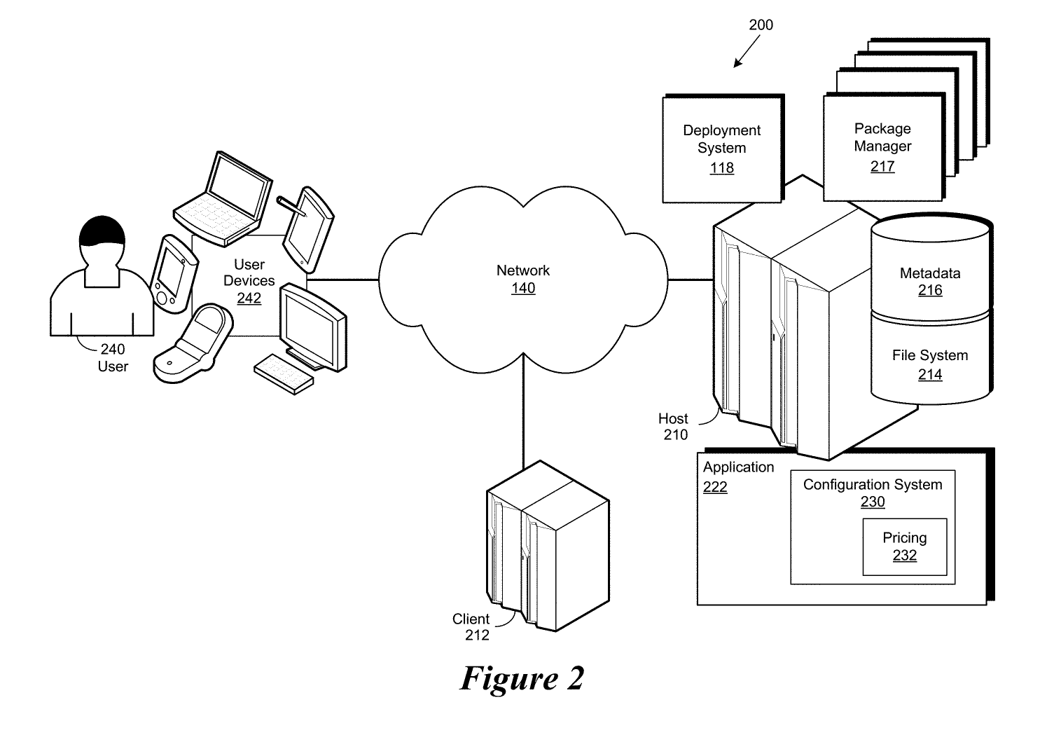

FIG. 2 is a simplified block diagram of deployment environment 200. In various embodiments, the deployment environment 200 includes a host system 210 and at least one client system 212. The host system 210 executes the deployment system 118 on a hardware processor. The host system 210 may also execute an application 222 (such as application 117) on a hardware processor. It will be appreciated that the host system 210 and the client system 212 may be respective information handling systems. The host system 210 includes one or more associated package managers 217. Each package manager 217 includes a collection of software tools that automate the process of installing, upgrading, configuring, and removing applications (or application components) in a consistent manner. Providing the deployment environment 200 with a package manager enables the deployment operation to be performed without the need to manage storage of the packages being deployed.

In various embodiments, the application 222 may comprise a configuration system 230. In various embodiments, the configuration system 230 may include a pricing module 232. In various embodiments, a user 240 may access the configuration system 230 executing on the host system 210 to configure a system such as an information handling system. In these and other embodiments, the user 240 may use a user device 242 to access the configuration system 230. In these embodiments, the user device 242 may be considered a client system.

As used herein, a user device 242 refers to an information handling system such as a personal computer, a laptop computer, a tablet computer, a personal digital assistant (PDA), a smart phone, a mobile telephone, or other device that is capable of communicating and processing data. In various embodiments, the user device 242 is used to exchange information between the user 240 and the host system 210 through the use of a network 140. In various embodiments, information is exchanged between the user device 242 and an application module (e.g., application module 117) executing on the host system 210. In certain embodiments, the network 140 may be a public network, such as the Internet, a physical private network, a wireless network, a virtual private network (VPN), or any combination thereof. Skilled practitioners of the art will recognize that many such embodiments are possible and the foregoing is not intended to limit the spirit, scope or intent of the invention. In various embodiments, the deployment system 118 provides a dispatcher function such that when a message is generated by an application module, the deployment system 118 decides whether to deploy and load the application module if needed or to just forward the message.

In various embodiments, the application modules (such as application modules 119) may be stored in the package manager 217. In various embodiments, some or all of the package managers 217 are associated with one or more other hosts in which case the application modules would be stored in the file system of the host on which the package manager resides. In various embodiments, the metadata may be stored in the metadata repository 216. The application modules and the metadata are then processed by the deployment system 118 to perform a deployment operation. It will be appreciated that the metadata may be distributed across multiple metadata repositories associated with different systems. In various embodiments, the metadata repository and the configuration system 230 may execute on a system other than the host system 210 and may communicate with the host system 210 via the network 140.

In various embodiments, the deployment system 118 executes on the host system 210. The deployment system 118 maintains application module information. The application module information includes some or all of module name information, package version information, application domain (AppDomain) reference information and module entry point class information. In certain embodiments, the application module information is maintained as a list of loaded modules.

The deployment operation transparently performs partial deployments when new functionality or updates are available for an application or application module. In various embodiments, each of a plurality of application modules encapsulate isolated functionality for an application. In various embodiments, each of the plurality of application modules has associated metadata. In various embodiments, the metadata comprises module name information, package manager endpoint information, package name information and type information. In various embodiments, the type information comprises a type representing an entry point for the module. For the purposes of this disclosure an entry point corresponds to a location where messages for a module are forwarded, at which location the hardware processor enters the application or application module and execution begins. In certain embodiments, the deployment system 118 is multithreaded and the entry point has a respective thread to handle messages sent to it.

The deployment system 118 loads application modules on demand. More specifically, when the host 210 receives a module command from the client system 212, the host 210 checks loaded module information to determine whether the requested application module is already loaded on the client system 212. For the purposes of this disclosure a module command may be defined as an instruction that includes a recipient module and parameters for that module. If the application module has been loaded on the client system 212 then the hosts 210 retrieves the module metadata from the metadata repository 216 by name. For the purposes of this disclosure module metadata may include data that describes a package manager endpoint, a package name and a type of module. Next, the host 210 contacts the package manager specified in the metadata and inquiries about the latest version of the package in the metadata (such as a latest version of an application module 117). If the package manager version is greater than the loaded version, then host 210 unloads and destroys the application domain reference for the application module which effectively unloads the module from memory. The host 210 removes the application module name from the loaded modules list.

If the application module is not loaded, the host system 210 retrieves the module metadata from the metadata repository 216 by name. The host system 210 contacts the package manager specified in the metadata and requests the latest version of the package specified in the metadata from the package manager. The host system 210 creates a new application domain (AppDomain) and proceeds to load all the extracted executable module components (e.g., via one or more dynamic link library (dll) files from the package into the new application domain. For the purposes of this disclosure an application domain comprises a mechanism used with a common language infrastructure (CLI) to isolate executable software application modules from one another so that they do not affect each other. Each application domain has a corresponding address space (which may be a virtual address space) which associates (i.e., scopes) the resources for the application domain using that address space. The host system 210 then creates an instance of the entry point class for the application module in the new application domain. The host 210 then updates the loaded modules list. The host 210 then forwards the module command to the entry point class for the application module.

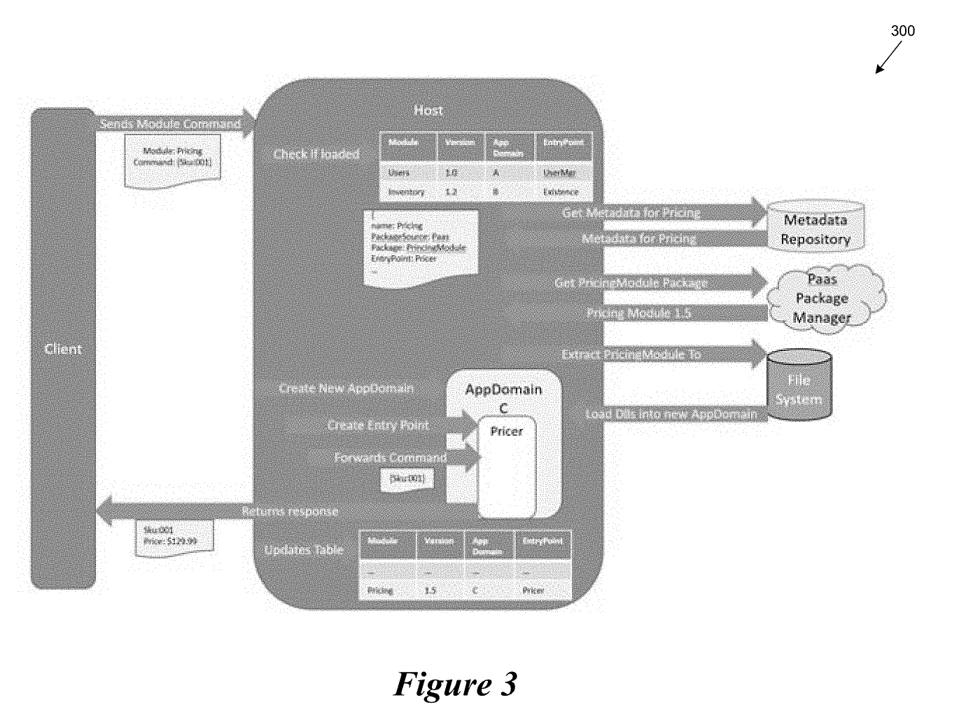

FIG. 3 shows a block diagram of the operation of a deployment environment 300 when a command is sent to a module that is not loaded on a client. More specifically, when the host system 210 receives a module command from the client system 212, the host system 210 checks loaded module information to determine whether the requested application module is already loaded on the host system 210.

If the application module is not loaded, the host system 210 retrieves the module metadata from the metadata repository 216 by name (e.g., metadata for pricing). The host system 210 contacts the package manager 217 specified in the metadata and downloads the latest version of the package specified in the metadata from the file system. The host system 210 creates a new application domain (AppDomain) and proceeds to load all the extracted executable module components (e.g., via one or more dynamic link library (dll) files for the package from the file system into the new application domain. The host system 210 then creates an instance of the entry point class for the application module in the new application domain. The host system 210 then forwards the module command to the entry point class for the application module. The host system 210 then returns a response to the client system 212 from executing the application module. The host system 210 then updates the loaded modules list to indicate that the application module has been loaded onto the host system 210.

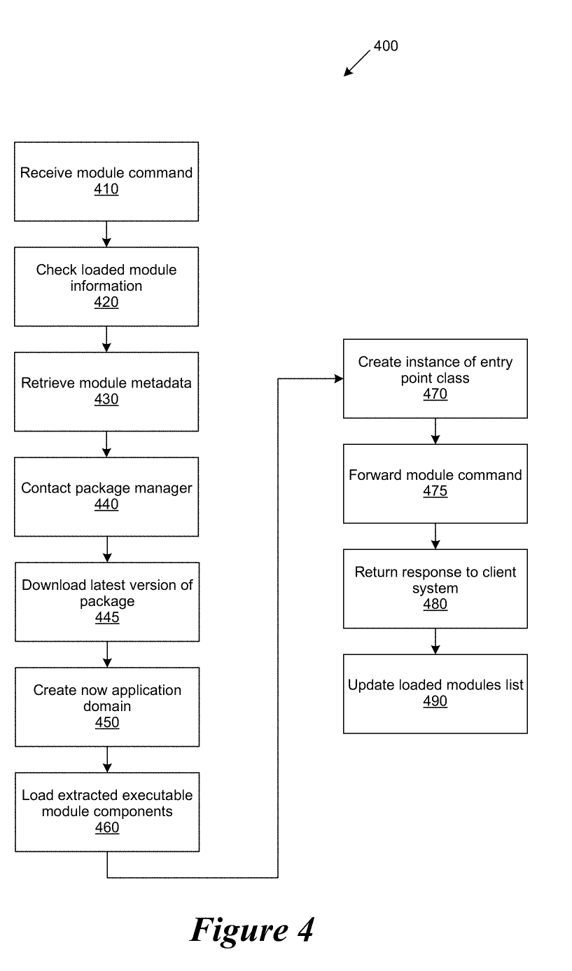

FIG. 4 shows a flow chart of a deployment operation 400 when a command is sent to a module that is not loaded on the host system 210. More specifically, the operation 400 beings with the host system 210 receiving a module command from the client system 212 at step 410. Next at step 420, the host system 210 checks loaded module information to determine whether the requested application module is already loaded on the host system 210.

If the application module is not loaded, then at step 430 the host system 210 retrieves the module metadata from the metadata repository 216 by name (e.g., metadata for pricing). Next at step 440, the host system 210 contacts the package manager specified in the metadata and downloads the latest version of the package specified in the metadata from the file system at step 445. The host system 210 then creates a new application domain (AppDomain) at step 450 and proceeds to load all the extracted executable module components (e.g., via one or more dynamic link library (dll) files for the package from the file system into the new application domain at step 460. Next at step 470, the host system 210 creates an instance of the entry point class for the application module in the new application domain. The host 210 then forwards the module command to the entry point class for the application module at step 475. Next at step 480, the host system 210 returns a response to the client system 212 from executing the application module. The host 210 then updates the loaded modules list to indicate that the application module has been loaded onto the host system 210 at step 490.

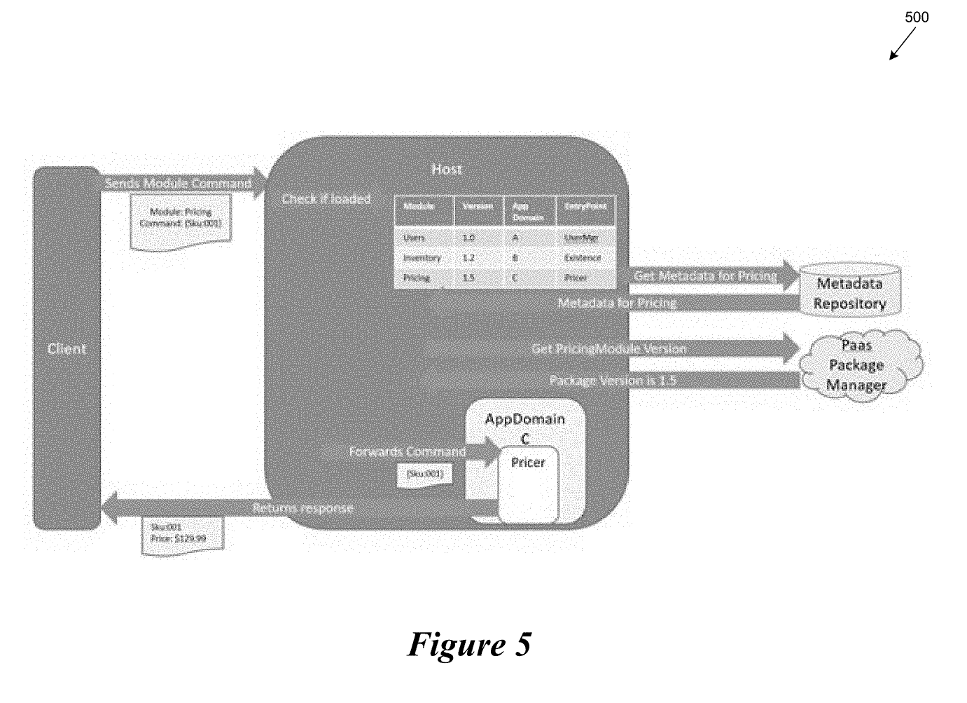

FIG. 5 shows a block diagram of the operation of a deployment environment 500 when a command is sent to a loaded application module that is current. When a module is already loaded, the host will check if the version in the package manager is more recent than the one loaded. If the loaded version is current then the deployment system simply forwards the command to the current entry point.

More specifically, when the host system 210 receives a module command from the client system 212, the host system 210 checks loaded module information to determine whether the requested application module is already loaded on the host system 210. If the application module has been loaded on the host system 210 then the host system 210 retrieves the module metadata from the metadata repository 216 by name. Next, the host system 210 contacts the package manager specified in the metadata and inquiries about the latest version of the package in the metadata. The host system 210 then forwards the module command to the entry point class for the application module. The host system 210 then returns a response to the client system 212 from executing the application module.

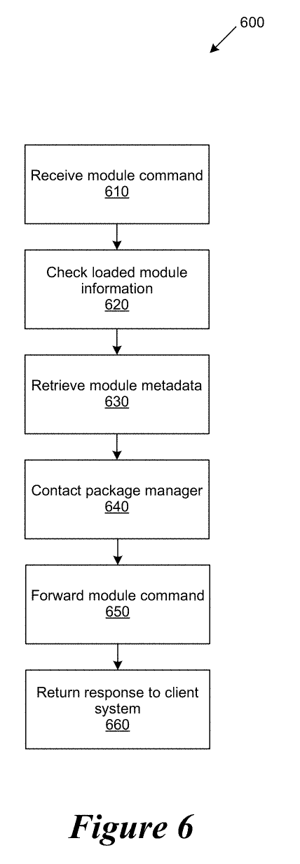

FIG. 6 shows a flow chart of a deployment operation 600 when a command is sent to a loaded application module that is current. More specifically, the host system 210 receives a module command from the client system 210 at step 610. Next, at step 620 the host system 210 checks loaded module information to determine whether the requested application module is already loaded on the host system 210. Because the application module has been loaded on the host system 210, the host system 210 retrieves the module metadata from the metadata repository 216 by name at step 630. Next at step 640, the host system 210 contacts the package manager specified in the metadata and inquiries about the latest version of the package in the metadata. The host system 210 then forwards the module command to the entry point class for the application module at step 650. The host system 210 then returns a response to the client system 212 from executing the application module.

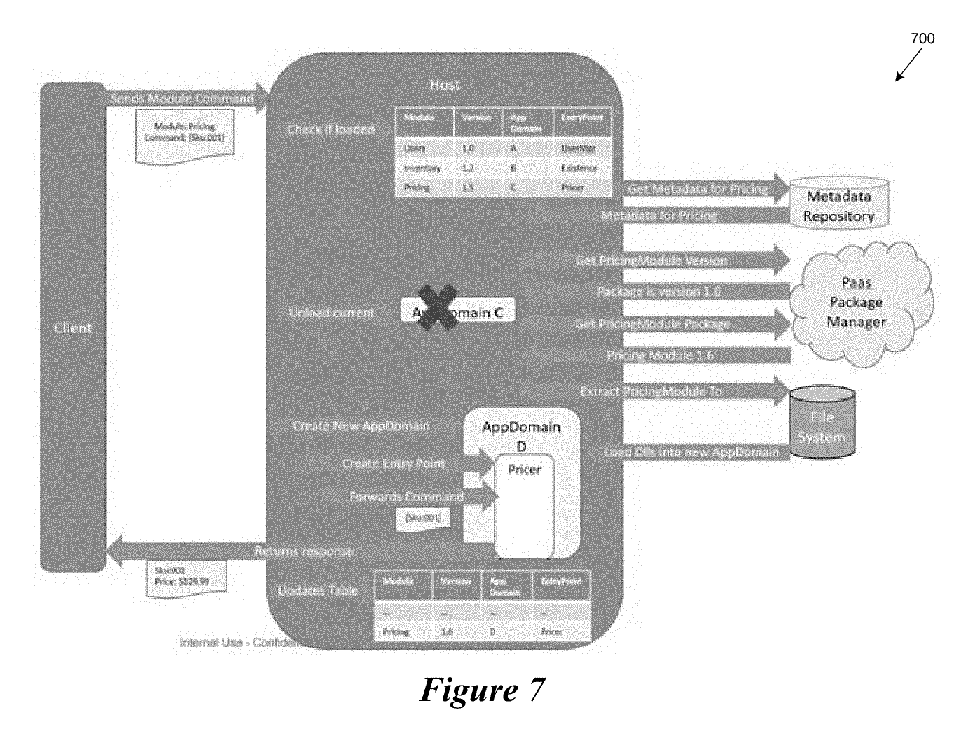

FIG. 7 shows a block diagram of the operation of a deployment environment 700 when a command is sent to a module that has a more recent version which is not loaded on a client. When a module is already loaded, the host system 210 check whether the version in the package manager is more recent than the one loaded. If that is the case the deployment system unloads the current version and reloads the fresher version from the package manager.

More specifically, when the host system 210 receives a module command from the client system 212, the host system 210 checks loaded module information to determine whether the requested application module is already loaded on the host system 210. More specifically, when the host 210 receives a module command from the client system 212, the host 210 checks loaded module information to determine whether the requested application module is already loaded on the host system 210. If the application module has been loaded on the host system 210 then the hosts 210 retrieves the module metadata from the metadata repository 216 by name. Next, the host 210 contacts the package manager specified in the metadata and inquiries about the latest version of the package in the metadata. If the package manager version is greater than the loaded version, then host 210 unloads and destroys the application domain reference for the application module. The host 210 removes the application module from the loaded modules list.

The host system 210 contacts the package manager and downloads the latest version of the package. The host system 210 creates a new application domain (AppDomain) and extracts the components of the latest version of the package to the file system 214. The host system 210 then proceeds to load all the extracted executable module components (e.g., via one or more dynamic link library (dll) files) from the package into the new application domain. The host system 210 then creates an instance of the entry point class for the application module in the new application domain. The host 210 then updates the loaded modules list with information regarding the newer version of the application module. The host 210 then forwards the module command to the entry point class for the application module.

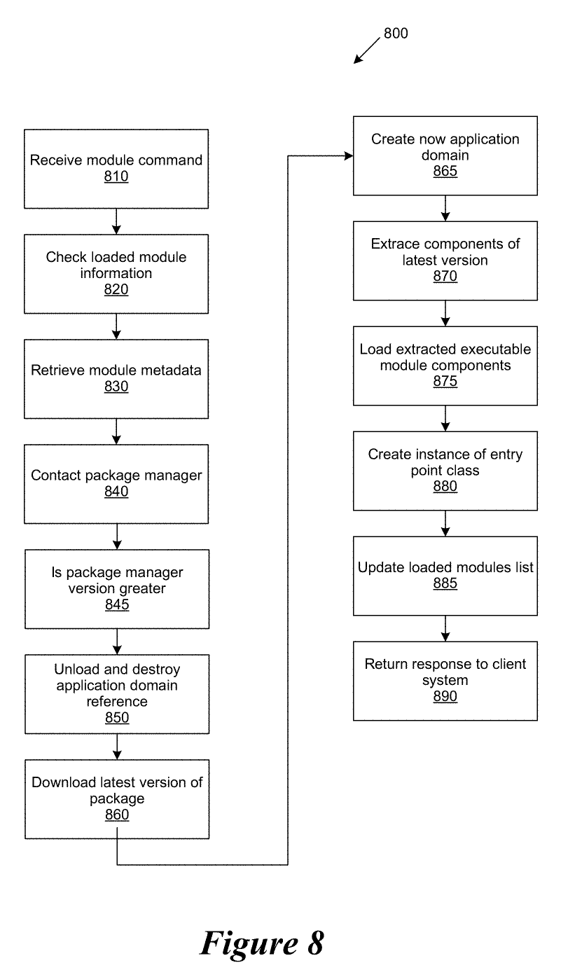

FIG. 8 shows a flow chart of a deployment operation when a command is sent to a module that has a more recent version which is not loaded on a client. More specifically, the host 210 receives a module command from the client system 212 at step 810. Next at step 820, the host 210 checks loaded module information to determine whether the requested application module is already loaded on the host system 210. If the application module has been loaded on the host system 210, then the host system 210 retrieves the module metadata from the metadata repository 216 by name at step 830. Next at step 840, the host 210 contacts the package manager 217 specified in the metadata and inquiries about the latest version of the package in the metadata. If the package manager version is greater than the loaded version as determined at step 845, then host 210 unloads and destroys the application domain reference for the application module at step 850. The host 210 then removes the application module from the loaded modules list at step 855.

Next, at step 860, the host system 210 contacts the package manager and downloads the latest version of the package. The host system 210 creates a new application domain (AppDomain) at step 865 and extracts the components of the latest version of the package to the file system 214 at step 870. The host system 210 then loads all the extracted executable module components (e.g., via one or more dynamic link library (dll) files) from the package into the new application domain at step 875. Next, at step 880, the host system 210 creates an instance of the entry point class for the application module in the new application domain. The host 210 then updates the loaded modules list with information regarding the newer version of the application module at step 885. The host 210 then forwards the module command to the entry point class for the application module at step 890.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, while the operation discloses obtaining the module dlls from a package stored in a package manager. Other options for obtaining the dlls are contemplated. For example, module dlls could be hosted in a shared file system or the host file system and accessed from there by the host. Also for example, while the operation discloses storing packages within a package manager, the packages could be stored in other locations such as a database.

Consequently, the invention is intended to be limited only by the spirit and scope of the appended claims, giving full cognizance to equivalents in all respects.

1. A computer-implementable method for performing a deployment operation, comprising:
receiving an application module command request;
accessing a metadata repository for application modules to obtain metadata corresponding to the application module, the metadata corresponding to the application module comprising module name information, package manager endpoint information, package name information and type information;
determining whether an application module corresponding to the application module command request is loaded within an application based upon metadata corresponding to the application module;
contacting a package manager to download an application module package if the application module is not loaded within the application or an update to the application module exists;
loading the application module package; and,
creating an entry point of module invocations, the entry point corresponding to a location where messages for the application module are forwarded, a hardware processor entering and beginning execution for the application module at the location.

2. The method of claim 1, wherein:
the deployment operation transparently performs partial application deployments when new functionality or updates to the application are available when the application module is accessed.

3. The method of claim 1, wherein:
the metadata repository stores application module metadata, the application module metadata comprising information about a package manager endpoint and package for each application module.

4. The method of claim 1, wherein:
the application module metadata includes information about the entry point for each application module.

5. The method of claim 1, wherein loading the application module package further comprises:
creating a new application domain (AppDomain) for the application module; and,
loading extracted executable module components from a package containing the application module into the new application domain.

6. The method of claim 5, wherein:
the extracted executable module components comprise one or more dynamic link library (dll) files contained within the package containing the application module.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
receiving an application module command request;
accessing a metadata repository for application modules to obtain metadata corresponding to the application module;
determining whether an application module corresponding to the application module command request is loaded within an application based upon metadata corresponding to the application module;
contacting a package manager to download an application module package if the application module is not loaded within the application or an update to the application module exists;
loading the application module package; and,
creating an entry point of module invocations.

8. The system of claim 7, wherein:
the deployment operation transparently performs partial application deployments when new functionality or updates to the application are available when the application module is accessed.

9. The system of claim 7, wherein:
the metadata repository stores application module metadata, the application module metadata comprising information about a package manager endpoint and package for each application module.

10. The system of claim 7, wherein:
the application module metadata includes information about the entry point for each application module.

11. The system of claim 7, wherein loading the application module package further comprises instructions for:
creating a new application domain (AppDomain) for the application module; and,
loading extracted executable module components from a package containing the application module into the new application domain.

12. The system of claim 11, wherein:
the extracted executable module components comprise one or more dynamic link library (dll) files contained within the package containing the application module.

13. A non-transitory, computer-readable storage medium embodying computer program code, the computer program code comprising computer executable instructions configured for:
receiving an application module command request;
accessing a metadata repository for application modules to obtain metadata corresponding to the application module;
determining whether an application module corresponding to the application module command request is loaded within an application based upon metadata corresponding to the application module;
contacting a package manager to download an application module package if the application module is not loaded within the application or an update to the application module exists;
loading the application module package; and,
creating an entry point of module invocations.

14. The non-transitory, computer-readable storage medium of claim 13, wherein:
the deployment operation transparently performs partial application deployments when new functionality or updates to the application are available when the application module is accessed.

15. The non-transitory, computer-readable storage medium of claim 13, wherein:
the metadata repository stores application module metadata, the application module metadata comprising information about a package manager endpoint and package for each application module.

16. The non-transitory, computer-readable storage medium of claim 13, wherein:
the application module metadata includes information about the entry point for each application module.

17. The non-transitory, computer-readable storage medium of claim 13, wherein loading the application module package further comprises instructions for:
creating a new application domain (AppDomain) for the application module; and,
loading extracted executable module components from a package containing the application module into the new application domain.

18. The non-transitory, computer-readable storage medium of claim 17, wherein:
the extracted executable module components comprise one or more dynamic link library (dll) files contained within the package containing the application module.
